(19) United States
(12) Patent Application Publication
(10) Pub. No.: US 2023/0305542 A1
(43) Pub. Date: Sep. 28, 2023

(54) MANUFACTURING MANAGEMENT SYSTEM

(71) Applicant: FANUC CORPORATION, Minamitsuru-gun, Yamanashi (JP)

(72) Inventors: Masahiro MORIOKA, Yamanashi (JP); Shinsuke SAKAKIBARA, Yamanashi (JP)

(21) Appl. No.: 18/017,245

(22) PCT Filed: Jul. 26, 2021
(86) PCT No.: PCT/JP2021/027555

§ 371 Date: Jan. 20, 2023

(30) Foreign Application Priority Data
Jul. 29, 2020 (JP) 2020-128116

(51) Int. Cl. G05B 19/418

(52) U.S. Cl. CPC G05B 19/41875; G05B 2219/32368

(57) ABSTRACT

Provided is a manufacturing management system making it possible to respond flexibly in accordance with a production status. This manufacturing management system comprises: a stationary device that is installed inside a work space; a mobile device able to move within the work space; and a server for extracting at least operational state data of the stationary device and the mobile device, and monitoring a production status on the basis of the operational state data. The server derives a deviation between the production status and a predetermined production plan as a production deviation, and corrects the operational state of the stationary device and/or the mobile device so as to reduce the production deviation.

### TECHNICAL FIELD

The present invention relates to a manufacturing management system.

### BACKGROUND ART

In the known art, a technique has been proposed in which workpieces are machined and assembled by a machining system including manufacturing devices such as a machine tool, a numerical control device, a robot, and a robot controller (see, for example, see Patent Document 1). The machining system of Patent Document 1 has a function of predicting machining completion time of the manufacturing apparatuses in order to increase operating rates.

Patent Document 1: Japanese Unexamined Patent Application, Publication No. 2015-182173

### DISCLOSURE OF THE INVENTION

### Problems to be Solved by the Invention

Such a machining system including a plurality of manufacturing devices is arranged at an appropriate position in a manufacturing factory such that the operating rates of the manufacturing devices, the throughput of machining and assembling, and the like can be improved.

However, it is difficult to flexibly adjust the layout of an existing manufacturing factory to an increase in the number of the manufacturing devices or an increase in the number of workpieces to be machined or assembled by the manufacturing devices. Under these circumstances, there is a demand for a system capable of flexibly adjusting to production statuses.

### Means for Solving the Problems

A manufacturing management system according to the present disclosure includes: a stationary device installed in a workspace; a mobile device capable of moving in the workspace; and a server configured to extract at least operational state data relating to the stationary device and the mobile device, and monitor a production status based on the operational state data. The server derives, as a production deviation, a deviation between the production status and a predetermined production plan, and corrects an operational state of at least one selected from the stationary device and the mobile device such that the production deviation is reduced.

### Effects of the Invention

The present invention makes it possible to flexibly manage production statuses.

### BRIEF DESCRIPTION OF THE DRAWINGS

FIG. 1 is a diagram illustrating an outline of a manufacturing management system according to an embodiment;

FIG. 2 is a block diagram illustrating a functional configuration of the manufacturing management system according to the embodiment; and

FIG. 3 is a block diagram illustrating a functional configuration of a server according to the embodiment.

### PREFERRED MODE FOR CARRYING OUT THE INVENTION

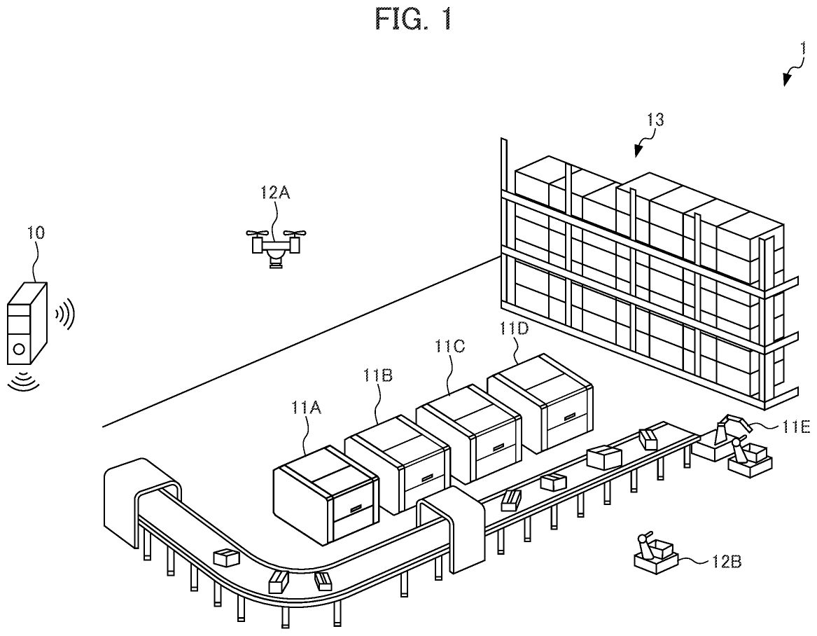

An example of embodiments of the present invention will be described below. FIG. 1 is a diagram illustrating an outline of a manufacturing management system 1 according to the present embodiment. The manufacturing management system 1 includes a server 10, stationary devices 11A to 11E, and mobile devices 12A and 12B. The manufacturing management system 1 machines and assembles workpieces including materials and parts by means of the server 10, the stationary devices 11A to 11E, and the mobile devices 12A and 12B, thereby manufacturing predetermined products.

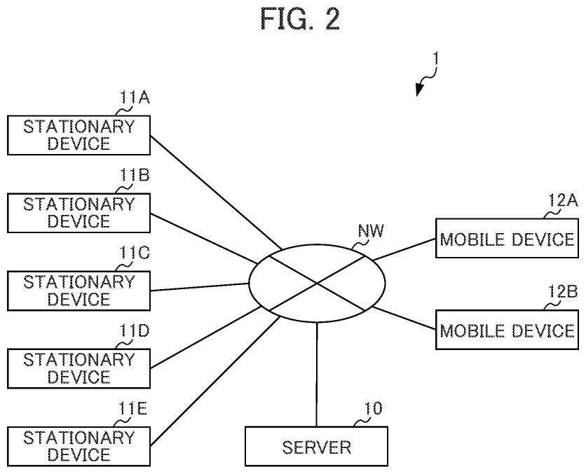

FIG. 2 is a block diagram illustrating a functional configuration of the manufacturing management system 1 according to the present embodiment. As illustrated in FIG. 2, the server 10 is communicatively connected to the stationary devices 11A to 11E and the mobile devices 12A and 12B via a network NW. The server 10 acquires various types of information from the stationary devices 11A to 11E and the mobile devices 12A and 12B, or transmits various types of control signals to the stationary devices 11A to 11E and the mobile devices 12A and 12B.

The stationary devices 11A to 11E and the mobile devices 12A and 12B are each communicatively connected to the server 10 via the network NW. It is desirable that the stationary devices 11A to 11E and the mobile devices 12A and 12B are communicatively connected to the server 10 via, for example, wireless communication.

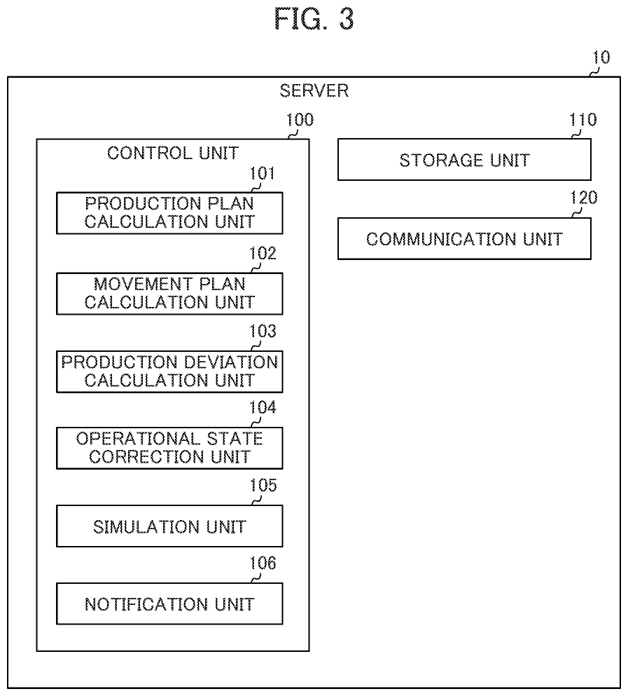

FIG. 3 is a block diagram illustrating a functional configuration of the server 10 according to the present embodiment. As illustrated in FIG. 3, the server 10 includes a control unit 100, a storage unit 110, and a communication unit 120.

Various functions of the control unit 100 are implemented by, for example, a processor such as a CPU executing programs (software) stored in a storage device. Some or all of these functional units may be implemented by hardware such as a LSI, an ASIC, or a FPGA, or may be implemented by cooperation of software and hardware.

The storage unit 110 is implemented by, for example, a storage device including a non-transitory storage medium such as a HDD, a flash memory, an EEPROM, or a ROM, or by a RAM. The storage unit 110 stores various types of information regarding the manufacturing management system 1.

The communication unit 120 is a communication interface for communicating with the stationary devices 11A to 11E and the mobile devices 12A and 12B via the network NW. The communication unit 120 communicates with the stationary devices 11A to 11E and the mobile devices 12A and 12B mainly by wireless communication.

The control unit 100 includes a production plan calculation unit 101, a movement plan calculation unit 102, a production deviation calculation unit 103, an operational state correction unit 104, a simulation unit 105, and a notification unit 106.

The production plan calculation unit 101 analyzes information regarding, for example, design specifications required for products, manufacturing facilities, and orders from customers. Based on the analysis results, the production plan calculation unit 101 calculates a production plan that includes, for example, information regarding the number of products to be produced per unit time (or unit period) on a type-by-type basis and the type and number of workpieces required for the production of the products, and information relating to the foregoing information, such as materials and parts to be used, the number and types of devices (e.g., the stationary devices 11A to 11E) to be provided, a layout for the devices, and order in which the devices are used. The production plan calculated by the production plan calculation unit 101 is stored in the storage unit 110.

Based on the calculated production plan, the movement plan calculation unit 102 calculates movement plan (transfer plan) information for each type of workpieces, parts, and products to be transferred between the stationary devices 11A to 11E. For example, the movement plan (transfer plan) information indicates, for each type, which one of the mobile devices 12A and 12B is to be used for transfer from which stationary device to which stationary device, a transfer timing, the number to be transferred per unit time (or unit period), and a movement path (transfer path) and a movement time (transfer time) related to the transfer. The movement plan (transfer plan) information calculated by the movement plan calculation unit 102 is stored in the storage unit 110.

Further, the movement plan (transfer plan) information is notified from the server 10 to the mobile devices 12A and 12B, etc. via the network NW (for example, wireless communication). The server 10 notifies, to each of the stationary devices 11A to 11E, a loading timing and an unloading timing of the workpieces, etc. This configuration makes it possible to produce products in cooperation between the stationary devices 11A to 11E and the mobile devices 12A and 12B, based on the optimal transfer plan.

In order to perform matching between each of the mobile devices 12A and 12B and a workpiece to be transferred thereby, it is necessary to identify individual workpieces. For this reason, it is preferable to attach a unique wireless tag to each workpiece, for example. The matching can be performed in such a manner that mobile devices 12A and 12B read the ID of the wireless tag via wireless communication and provide a notification of the read ID to the server 10. In this way, the mobile devices 12A and 12B can identify the workpiece and thereby identify the destination of the transfer.

Next, the stationary devices 11A to 11E and the mobile devices 12A and 12B will be described. The production deviation calculation unit 103 and the units subsequent thereto will be described later.

The stationary devices 11A to 11E are manufacturing devices fixedly installed in a workspace such as a manufacturing factory. Specifically, the stationary devices 11A to 11E are each a manufacturing device configured to perform at least one selected from machining, assembly, coating, cleaning, inspection, and packaging, and include, for example, a machine tool, a numerical control device, a robot, a robot controller, and an injection molding machine. For example, as illustrated in FIG. 1, the stationary devices 11A to 11D may be machine tools for machining workpieces, and the stationary device 11E may be a robot for assembling the workpieces.

The mobile devices 12A and 12B are devices capable of transferring an article (for example, a workpiece) to be used in the workspace. Specifically, each of the mobile devices 12A and 12B may be an unmanned aircraft, a conveyance device, an automated guided vehicle (AGV), or the like.

An unmanned aircraft is an aircraft configured to be used without a person aboard, and flies with a motor driven by a battery or the like. Examples of such an unmanned aircraft include drones, helicopters, multi-copters, quadcopters, tilt-wing aircrafts, etc.

The mobile devices 12A and 12B are used to transfer a workpiece from a stocker 13 where the workpieces including parts and materials are stored, or the stationary devices 11A to 11E. For example, as illustrated in FIG. 1, the mobile device 12A is a drone and has a mechanism for hanging and releasing a workpiece. The mobile device 12B is an AGV and has a transferring mechanism for transferring a workpiece.

The mobile devices 12A and 12B may be centrally managed by the server 10. Specifically, the server 10 centrally manages a movement path, a movement speed, an altitude, and the like of each of the mobile devices 12A and 12B according to a predetermined operation program. The movement speeds of the mobile devices 12A and 12B may be set to the same predetermined speed.

In the present embodiment, the production deviation calculation unit 103 extracts at least operational state data relating to the stationary devices 11A to 11E and operational state data relating to the mobile devices 12A and 12B, and monitors the production status based on the operational state data.

Here, the operational state data relating to the stationary devices 11A to 11E includes information indicating, for example, an operating rate of each of the stationary devices 11A to 11E, whether or not the number of workpieces as machining targets agree with the number preset in the production plan, whether or not the number of final products as machining targets agrees with the number preset in the production plan.

The operational state data relating to the mobile devices 12A and 12B includes information indicating, for example, a position of each of the mobile devices 12A and 12B, an operating rate of each of the mobile devices 12A and 12B, a transfer time for each of the mobile devices 12A and 12B to transfer a workpiece. Furthermore, the operational state data relating to the mobile devices 12A and 12B may include information indicating, for example, whether or not each of the mobile devices 12A and 12B is transferring the workpiece, between which ones of the stationary devices each of the mobile devices 12A and 12B is transferring the workpiece, whether or not each of the mobile devices 12A and 12B is at a standstill, whether or not the number of the workpieces transferred agrees with the number preset in the production plan, and whether or not the workpieces have been transferred to the destination preset in the production plan. Here, the production status indicates the number of products currently manufactured by the manufacturing management system 1 and a state of progress.

The production deviation calculation unit 103 derives, as a production deviation, a deviation between the production status and the predetermined production plan. The production deviation indicates a deviation (difference) of the actual number of products and the actual state of progress from the number of products and the state of progress predetermined in the production plan.

The operational state correction unit 104 corrects the operational state of at least one of the stationary devices 11A to 11E and the mobile devices 12A and 12B such that the derived production deviation is reduced.

Specifically, for example, in a case where a production deviation is caused with respect to the stationary devices 11A to 11E due to a shortage of supply of the workpieces transferred by the mobile device 12A, the operational state correction unit 104 may correct the movement plan (transfer plan) information to increase the supply of the workpieces to be transferred by the mobile device 12A such that the operational state is corrected so as to reduce the production deviation.

In a case where production deviation is caused due to a shortage of the number of workpieces machined or assembled by, for example, the stationary device 11A, the operational state correction unit 104 may correct the operational state by increasing the production by way of addition of another stationary device 11A (the addition involving a change in the layout). The addition of any of the stationary devices 11A to 11E is performed by, for example, installing a new stationary device or operating an unused stationary device. In accordance with this, the operational state correction unit 104 may correct the movement plan information such that the supply of the workpieces to be transferred by the mobile device 12A increases.

The simulation unit 105 may perform, for example, simulation to check whether the production deviation will be reduced by correction of the movement plan (transfer plan) information, before the operational state is actually corrected. Likewise, before a stationary device 11A is actually added, the simulation unit 105 may simulate, for example, not only the addition of the stationary device, but also a change in the layout, addition of movement plan (transport plan) information, etc. that are caused by the addition of the stationary device 11A and thereby checks whether the production deviation will be reduced.

The operational states of the stationary devices 11A to 11E are corrected desirably at a timing when a program for the stationary devices 11A to 11E to machine or assemble workpieces is changed, or when workpieces to be machined or assembled by the stationary devices 11A to 11E are switched to different workpieces.

The operational state correction unit 104 can derive, based on the operational state data, one(s) having a low operating rate from among the plurality of stationary devices 11A to 11E and/or one having a low operating rate from the mobile devices 12A and 12B. The operational state correction unit 104 may correct the operational state of the device with the low operating rate among the stationary devices 11A to 11E and/or the mobile devices 12A and 12B such that the derived operating rate increases, thereby reducing the production deviation.

Specifically, for example, in a case where the operating rate of the stationary device 11A is determined to be low as a result of deriving the operating rates of the stationary devices 11A to 11E and/or the mobile devices 12A and 12B, the operational state correction unit 104 corrects the operational state of the stationary device 11A by increasing the operating rate of the stationary device 11A.

The notification unit 106 can provide an administrator (or operator) with notification that in order to increase the operating rate of the stationary device 11A, the machining speed of the stationary device 11A will be increased, the number of workpieces to be transferred to the stationary device 11A by the mobile devices 12A and 12B will be increased, and defects (e.g., damage to a tool) of the stationary device 11A will be eliminated. In this way, the administrator (or operator) can provide appropriate instructions to the stationary device 11A and/or the mobile devices 12A and 12B.

As described above, in the case where a low operating rate of the stationary device 11A is caused due to, for example, a situation in which the number of workpieces, parts, or the like transferred by the mobile device 12A to the stationary device 11A is smaller than the number preset in the production plan, the operational state correction unit 104 may correct the operational state of the mobile device 12A.

Although the stationary device 11A operates without an idling time, if the production is less than that preset in the plan, the operational state correction unit 104 may correct the operational state of the stationary device 11A such that the production by the stationary device 11A increases, as described above.

As described above, according to the present embodiment, the manufacturing management system 1 includes: the stationary devices 11A to 11E installed in a workspace; the mobile devices 12A and 12B capable of moving in the workspace; and the server 10 configured to extract at least the operational state data relating to the stationary devices 11A to 11E and the mobile devices 12A and 12B, and monitor the production status based on the operational state data. The server 10 derives, as a production deviation, a deviation between the production status and a predetermined production plan, and corrects the operational state of at least one selected from the stationary devices 11A to 11E and the mobile devices 12A and 12B such that the production deviation is reduced. Due to this feature, the manufacturing management system 1 corrects the operational states of the stationary devices 11A to 11E and the mobile devices 12A and 12B such that the production deviation is reduced, thereby flexibly managing the production statuses and enabling improvement of productivity.

The stationary devices 11A to 11E are each a manufacturing device that performs at least one selected from machining and assembly, and the mobile devices 12A and 12B include at least an unmanned aircraft capable of transferring an article to be used in the workspace. Thus, using the unmanned aircraft allows the manufacturing management system 1 to freely transfer workpieces without being affected by the layout on the floor of the workspace. As a result, the manufacturing management system 1 can flexibly manage the production statuses and improve productivity.

The operational state data relating to the mobile devices 12A and 12B includes the position, the operating rate, and the transfer time of the mobile devices 12A and 12B. Due to this feature, the manufacturing management system 1 can appropriately correct the operational states of the mobile devices 12A and 12B based on the operational state data of the mobile devices 12A and 12B.

Further, the server 10 derives, based on the operational state data, at least one stationary device having a low operating rate from among the plurality of stationary devices 11A to 11E and/or at least one mobile device having a low operating rate from the mobile devices 12A and 12B, and corrects the operational state of the at least one stationary device having the low operating rate and/or the operational state of the at least one mobile device having the low operating rate such that the production deviation is reduced. Due to this feature, the manufacturing management system 1 can appropriately correct the operational state of the at least one of the stationary devices 11A to 11E having the low operating rate and/or the operational states of at least one of the mobile devices 12A and 12B having the low operating rate.

While an embodiment of the present invention has been described in the foregoing, the manufacturing management system 1 described above can be implemented by hardware, software, or a combination thereof. Moreover, a control method performable by the manufacturing management system 1 described above can be implemented by hardware, software, or a combination thereof. Here, the implementation by software means that a computer reads and executes a program for the implementation.

The program can be stored in various types of non-transitory computer readable media and can be provided to a computer. The non-transitory computer readable media include various types of tangible storage media. Examples of the non-transitory computer readable media include a magnetic recording medium (e.g., a hard disk drive), a magnetic-optical recording medium (e.g., a magnetic optical disk), a read only memory (CD-ROM), a CD-R, a CD-R/W, and a semiconductor memory (e.g., a mask ROM, a programmable ROM (PROM), an erasable PROM (EPROM), a flash ROM, and a random access memory (RAM).

Although the above-described embodiment is a preferred embodiment of the present invention, the scope of the present invention is not limited to the above-described embodiment. The present invention can be worked with various modifications made without departing from the spirit of the present invention.

### EXPLANATION OF REFERENCE NUMERALS

1: Manufacturing Management System
10: Server
11A to 11E: Stationary Device
12A, 12B: Mobile Device
13: Stocker
100: Control Unit
101: Production Plan Calculation Unit
102: Movement Plan Calculation Unit
103: Production Deviation Calculation Unit
104: Operational state Correction Unit
105: Simulation Unit
106: Notification Unit
110: Storage Unit
120: Communication Unit

1. A manufacturing management system comprising:
a stationary device installed in a workspace;
a mobile device capable of moving in the workspace; and
a server configured to extract at least operational state data relating to the stationary device and the mobile device, and monitor a production status based on the operational state data,
wherein the server derives, as a production deviation, a deviation between the production status and a predetermined production plan, and corrects an operational state of at least one selected from the stationary device and the mobile device such that the production deviation is reduced.

2. The manufacturing management system according to claim 1,
wherein the mobile device includes at least an unmanned aircraft capable of transferring an article to be used in the workspace.

3. The manufacturing management system according to claim 1,
wherein the operational state data of the mobile device includes a position of the mobile device, an operating rate of the mobile device, and a transfer time for the mobile device to transfer an article.

4. The manufacturing management system according to claim 2,
wherein the stationary device comprises a plurality of stationary devices, and the mobile device comprises a plurality of mobile devices, and
wherein the server derives, based on the operational state data, at least one stationary device having a low operating rate from among the plurality of stationary devices and/or at least one mobile device having a low operating rate from among the plurality of mobile devices, and corrects the operational state of the at least one stationary device having the low operating rate and/or the operational state of the at least one mobile device having the low operating rate such that the production deviation is reduced.
